(19) United States
(12) Patent Application Publication
(10) Pub. No.: US 2010/0108247 A1
(43) Pub. Date: May 6, 2010

(54) Method and Apparatus for a Retro-reflective Material

(76) Inventor: Tao-Ming Tom King, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/376,120

(22) PCT Filed: Aug. 17, 2007
(86) PCT No.: PCT/US07/18265

§ 371 Date: Oct. 30, 2009

Related U.S. Application Data
(63) Continuation-in-part of application No. 11/496,687, filed on Aug. 1, 2006, now abandoned.
(60) Provisional application No. 60/842,861, filed on Sep. 8, 2006.

(51) Int. Cl. B32B 38/10

(52) U.S. Cl. 156/247

(57) ABSTRACT

A process of making a micro glass beaded retro-reflective material comprising micro glass beads lenses, which are partially embedded in graphic matrixes of binding material. The pre-fixed rotating axes of the micro glass beads lenses lie at varying angles to the general plane of the graphic matrix to achieve uniform visibility in broad range of entrance and observation angles. The gaps between the graphic matrixes allow the permeability, flexibility, softness and color of the base material to be maintained.

This application is a Continuation in Part of International application number PCT/US2007/018265 with an international filing date of Aug. 17, 2007 and which is incorporated herein in its entirety by reference; and which claims priority to U.S. patent application Ser. No. 11/496,687 filed Aug. 1, 2006 and which is incorporated herein in its entirety by reference.

### BACKGROUND OF THE INVENTION

1. Field of the Invention

The present invention relates to textile manufacturing employing micro glass beads in the structure of the formed fabric. More particularly it relates to an improved retro reflective textile fabric, employing micro glass bead lenses engaged in random directions for improved performance.

2. Prior Art

The placement of glass beads upon a surface to create a reflective surface has been conventionally employed for some time. In general, glass beads having a reflective coating on a rearward surface and are engaged to an adhesive sheet on their front surfaces. These front surfaces provide a lens for the reflection through the glass.

However, because the reflective surfaces are generally finally located to the resulting fabric, upon the other side from the adhesive surface holding the beads in a pattern, when such beads are engaged to an eventual substrate providing the mounting surface, they all have the same or a very similar reflective angle which is substantially perpendicular to the planar surface to which they are engaged on adjacent to their mirrored or metallized side.

Other approaches have been taken such as nesting multiple layers of glass beads into a coating of clear adhesive which cures to hold the reflective beads at various angles to the mounting surface. However in this mode of engagement, substantial impairment of the reflection from many angled glass beads occurs impairing overall performance. This is caused by upper situated layers of beads tending to block light transmission and the reflections from the underlying glass beads since they will intercept incoming light before it hits underlying beads.

A number of conventional approaches have been employed to enhance reflective qualities of substrate fabric engaged to reflective glass beads. However, to date, conventional reflective fabrics employing such reflective beads still lack the wide angle of incidence and reflection and high light transmission characteristics provided by the device of the method disclosed herein.

U.S. Pat. No. 3,989,775 teaches a beaded retro-reflective substrate fabric employing embedded beads, having a reflective surface generally parallel to the surface of the planar substrate material. The material is then embossed to increase observation angles of the beaded reflective surfaces which assume angles following the curve of the embossment in the substrate fabric. However, this method is not well received for clothing for safety since most of common base materials employed, such as cotton fabric, polyester fabric, nylon fabric, paper, PVC (Polyvinyl Chloride), sheeting, and PU (Polyurethane) sheeting, are highly elastic. This elasticity renders the substrate fabric unsuitable for embossment. Therefore, the application of the embossed surface bead engagement is limited generally to plastic materials or those that will not stretch and remove the embossment or beads.

U.S. Pat. No. 4,763,985 discloses another mode for a retro-reflective sheet. The retro-reflective construction comprising a monolayer of transparent micro spheres over a base layer of transparent binder material mixed with reflective nacreous pigment flake. The disadvantage of this construction is that the binder material in the base layer will always get in between the micro sphere lenses and the reflective nacreous pigment flake. As a consequence, the reflectivity is reduced.

The approach of U.S. Pat. No. 5,128,804, U.S. Pat. No. 6,861,134, U.S. Pat. No. 5,344,705 and U.S. Pat. No. 5,620,613, teaches retro-reflective transfer sheeting, or reflective transfer sheeting with pores, or reflective transfer sheeting with color layers. This construction of bead based reflective materials employs a construction where the sheeting is a two-sided web of thermoplastic filaments. A first side has reflective elements (micro glass bead lenses) partially embedded or laminated, and the opposite side is simply a planar substrate.

In assembly, the subject sheet with reflective elements on the first side may be laminated to a base material like fabric by heating. The disadvantage of using a permeable sheet for the substrate is that the water and detergent can penetrate the sheet easily reducing the bonding between the micro glass bead lenses and the fabric substrate during laundering.

Further, when the retro-reflective elements are embedded in the filaments on one side, the pores of the permeable substrate are mostly blocked by the micro glass bead lenses. Additionally, the retro-reflective sheeting is not a final product. To function, in final form, it needs to be heat laminated to a base material by end users. If the melting point is low, such as the 40 to 60 degree Celsius as suggested in U.S. Pat. No. 5,128,804, the sheeting requires difficult handling during storage and transportation. This is because when the reflective products are in transit, should the temperature inside trucks or containers reach above 60 degree Celsius, it can activate the bonding process temporarily. The bonding strength will be reduced by each cycle of such temperature fluctuation during shipment.

Also, should such reflective fabric employ a bonding agent with a low melting temperature, it will suffer from poor performance in hot or warm water washes.

On the other hand, if the melting point for the bonding agent is a high temperature such as the 250 degree Celsius suggested in U.S. Pat. No. 5,128,804 other problems can occur. This is especially evident with synthetic fabrics and with many color pigments colorizing the base fabric. The employment of the required high heat to laminate the reflective glass beads to the substrate will tend to change the shape of the fabric substrate by when the heat effects the yarns, or will be detrimental to the color of the fabric substrate by affecting the dye.

An additional shortcoming of conventional glass bead reflective fabric occurs in the light reflection performance of the final retro-reflective product. As noted above, the resulting final product, with reflective glass beads engaged to the surface of an underlying substrate, is heavily dependent on the final process of laminating the retro-reflective bead-engaged sheeting, to a base substrate material using a heat process.

The heat lamination process is conventionally performed by end users who purchase the bead-engaged reflective sheeting and then laminate it to a garment or fabric in the process of manufacturing the garment. Generally used are either a heat press machine or a heating iron.

The wide variance in end-user procedures and machinery for lamination of the heat-sensitive bead engaged retro-reflective sheeting, a highly heat sensitive material, and the shipping of the sensitive fabric in an uncontrollable freight environment, render it hard to control the finished product quality.

In U.S. Pat. No. 5,200,262, U.S. Pat. No. 5,738,746, and U.S. Pat. No. 6,153,128, there was introduced launderable (washable) retro reflective applique and clothing bearing reflective applique. These products employ a reflective systems where the glass beads providing the reflection are fully covered by a binder layer.

The retro-reflective appliques in use in this mode, are sewn on or heat transferred to the end products, such as a clothing or fabric. The reflective applique material so employed consists of a monolayer of retro reflective bead elements. Under the retro reflective elements is a binder layer. In the finished product this positions the glass beads with their lenses partially embedded within and protruding from, the front surface of the binder layer in conjunction with aluminum coated or silver coated optical element. The clear or transparent part of the glass beads, all face the direction opposite of the binder layer in the same direction. However, the binder layer in covering the lens partly or in hole, severely impairs light transmission and reflection.

A similar approach in U.S. Pat. No. 5,900,978 is formation of retro reflective materials by a printed ink method. In such a method, metal-coated micro glass beads are mixed in a binder of transparent adhesive, and then printed, or painted using brushes, or scraped, onto the substrate base material in full coverage, or partial coverage. Because the micro glass bead lenses are mixed into the binder adhesive which is a liquid carrier, the binder material tends to flow and cover the clear part of micro glass bead lenses.

Covering the clear glass lens of the glass beads used for reflectors adds coating to their surface which alters the shape of the micro glass beads lens and its refraction, focus, and reflective capabilities. Further since the coating and the glass forming the beads have a different density, the retro-reflective effectiveness of the micro glass bead lenses is severely reduced.

Another approach is advanced in U.S. Pat. No. 6,859,941 and U.S. Pat. No. 6,974,610, which describe two graphic transfer systems which can be applied to place reflective surfaces upon high visibility safety apparel. The reflective system in these two patents employs a heat transfer system with a portion of stripe segments removed from a fully covered retro-reflective transfer sheet. The reflective system remains on the apparel are substantially continuous for the length of the stripe. The stripe segments are formed of retro-reflective material.

The disadvantage of the above method is that the removing of the stripe segment process is time consuming and with high defect rate. Using this method, the detail of the graphic pattern is limited by the size of the stripe to be removed. Also, to make the final product of reflective fabric or garment, the heat transfer process is performed by the end user and is not a part of the above patents. The final process of the retro-reflective transfer graphic system is a highly sensitive to heat, pressure and timing that the quality of the final product is hard to control.

As such, there is an unmet need for a reflective material which may be placed on a flexible substrate such as clothing and safety apparel. Such a material should provide a means of adherence which will not effect substrate color from a high heat process. Such a material should not be subject to the unpredictability and product degradation that can be imparted by shipping a low heat activated material over freight lines. Such a material should be easily user-engaged to fabric substrates such that a high quality reflective clothing is insured to be free of defects. Finally, the reflective qualities of the finished fabric should not be impaired by the glue or adhesive bonding the reflective components to the fabric.

In this respect, before explaining at least one embodiment of the method and apparatus of the disclosed invention in detail, it is to be understood that the invention is not limited in its application to the details of construction and to the arrangement of the components set forth in the following description or illustrated in the drawings nor the steps outlined in the specification. The invention is capable of other embodiments and of being practiced and carried out in various ways as those skilled in the art will readily ascertain from reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention which provides an easily employed, highly improved, reflective material which can be adhered to a substrate. It is important, therefore, that the claims be regarded as including such equivalent construction insofar as they do not depart from the spirit and scope of the present invention.

### SUMMARY OF THE INVENTION

As noted, a conventional employment of the retro reflective fabrics is as an appliqued fabric to an underlying substrate such as clothing or safety garments. So positioned, the reflective material functions to increase the wearer's visibility when situated in front of sources of oncoming light (such as from a headlight of a car). Such visibility on safety related clothing is required by criteria of safety standards such as ANSI/ISEA standard as shown in Reference 1.

The device and method herein employs a unique process to achieve a reflective material with enhanced reflective qualities from multiple angles which meets and exceeds safety standards such as those set by ANSI/ISEA. The improved device from the method is accomplished by applying the retro-reflective system component directly to the base fabric, or the body of a garment, rather than using an interface as with the prior art.

Additionally, the retro-reflective system herein described and disclosed can be provided in a graphic format to yield not only reflective qualities by designs and indica. Employment of the method and product therefrom herein, renders the final product lighter, permeable and has an much more aesthetic visual appearance.

When the area of coverage of the graphic shape or indicia to be imparted to the fabric substrate is over 80%, the retro reflective fabric device manufactured by the method herein is able to meet or exceed ANSI national safety standards for reflective qualities in a fabric. The graphic image or indicia produced using the disclosed retro reflective fabric is outlined by repeated array of small graphic shapes. These graphic shapes can include dots, squares, crosses, alphabets, numbers, and lines or other indica. The size of each graphic shape which can presently be produced can be in between 1 mm to 5 mm width. The space between the graphic shapes can be from 0.5 mm and larger.

As depicted in FIG. 2 herein, the edge of each of the graphics or indicia positioned on the substrate is curved yielding the micro glass bead lenses which are positioned facing a plurality of different directions. This provides a plurality of bright reflections at various angles, thereby increasing user visibility to wider observation angles from potential oncoming lights.

In the particularly preferred mode of the device and method depicted in FIG. 3 herein, the micro glass bead lenses may be sprinkled to the graphic binder matrix which is already positioned on the flexible fabric substrate. This employment of a sprinkled positioning places the lenses of the glass beads in positions facing a variety of directions. This plurality of positions and angles serve as a means to further enhance the user's visibility to third parties by providing a wide observation angle due to the wide angles of reflection provided by the lenses.

The disclosed method and device therefrom utilizes micro glass beads which are metal-coated by vacuum deposition. The aluminum molecular coatings are adhered directly in contact with a surface of each of the respective glass beads thereby rendering the unit reflectivity of each of the micro glass bead lenses to a level more than 200% brighter than the aforementioned conventional approach where the coating is adjacent to, but not adhered to the glass beads. In the bead forming process, the clear micro glass beads are engaged with a type of low temperature melting point PE film, by heat also known as LLDPE. The exposed part of the beads is metallized while it is still attached on the film. Then laminate the film to the sub stratum with adhesive and with pressure such that the beads adhere with the metallized portion engaged with the adhesive. Subsequently, the LLDPE film is removed from the beads leaving the clear part of beads deployed facing outside.

If cost reduction is a goal, a similar level of reflectivity may thus be achieved by using proportionally less micro glass bead lenses than the dimmer conventional mode which serves to reduce costs. The resulting fabric has enhanced elements of softness, permeability and an enhanced or different appearance. Should higher visibility be the goal, using the same amount of glass beads, having enhanced brightness, will significantly increase visibility from the conventional devices noted above which lack brightness and the plurality of angles of reflection when engaged to the fabric substrate.

The disclosed device and method employs a bonding agent which is solid and not permeable to thereby protect against moisture intrusion and improve the wash performance. The bonding agent is applied to the underlying fabric by a screen print or graver method yielding highly accurate placements of the bonding agent on the fabric. While shown in a curved dot shape, the bonding agent can be in other shapes to yield graphics on the garment in those shapes.

As shown in the drawings, two preferred types of bonding agents are employed in some of the modes of the device and method in layers. A first layer is a thin layer of Thermal Polymerization type of adhesive applied is from 100-180 degree Centigrade, on which the second layer is of a hot melt type of adhesive is positioned. By using two layers of adhesive in this fashion, the second layer of adhesive is prevented from bleeding to cover the front, or clear side of the micro glass bead lens. Further, by controlling the temperature and timing and viscosity of the mixture the beads are kept from sinking into the mixture and remain on top. The temperature to yield the proper viscosity is from 100 degree to 200 degree C., and the time is from 30 second to 3 minutes. The viscosity is thereby varied thereby from 1000 to 2000 cps.

Additionally, in the method and device therefrom disclosed herein, the Thermal Polymerization bonding agent and the hot melt type of adhesive are applied directly to the base material substrate, before the micro glass bead lenses are subsequently applied from their engagement upon a LLDPE film sheet which is a kind of low temperature melting point PE film. Thereafter, the micro glass bead lenses are embedded to the bonding agent prior to final curing of the bonding agent. The bonding agent so employed can adhere using a chemical reaction which requires less heat than conventional bonding agents. Therefore the process of proposed patent is suitable for broader range of base materials which heretofore might be damaged by high heat properties required to cure bonding agents. Once engaged to the bonding agent, the film is removed from the clear side of the beads leaving them in place.

Additionally, the disclosed method and device requires no binder layer. Instead, the binder is a separated graphic matrix which is placed on the fabric or clothing providing the substrate directly. The micro glass bead lenses are subsequently placed on the binder matrix facing various directions using the film engaged to the beads to position then on the adhesive.

An advantage of the method and device herein disclosed is that the end product, having the glass bead lenses adhered to the fabric substrate, is lighter, softer, permeable, and has graphic appearance provided by the adhered reflective glass bead lenses.

Using the method herein to produce the reflective material, it is feasible to cover an entire garment directly with the reflective bead lenses to the matrix, instead of the conventional method of an applique of separate fabric which covers only a portion of the garment. Or, a process to heat press a strip of none permeable reflective sheet onto portion of the garment can be employed. Further, employing the disclosed method herein, the binder matrix may cover only a selected portion of the base material providing the substrate. In this mode of the method, the color of the base material will be visible to observers so that the reflective system yielded by the method provides a colored appearance.

In a particularly preferred mode of the method herein, the resulting product positions all of the micro glass bead lenses in a manner which renders each embedded only partially on the surface of the binder adhesive. This improves upon the conventional manner which covers the glass bead lenses with adhesive or a bonding layer and thereby provides a reflectivity which is improved significantly.

Another noted shortcoming of the prior art is overcome by the method herein which eliminates the need for embossing the substrate to achieve a plurality of reflective angles of the resulting mounted glass bead lenses. Employing the disclosed method herein to yield the reflective product, a fabric is produced which has a generally planar substrate surface engaging the glass beads. However, the sprinkling of the glass beads upon the pre positioned binding layer, can also place the micro glass bead reflective surfaces and lenses in a plurality of reflective angles in a permanent manner. Thus, multiple angles of reflection of the finished material are provided on a flexible planar substrate.

Further, as noted, the method herein disclosed, allows for the glass beads lenses providing the reflect on, to be engaged to any type of fabric substrate such as woven or knitted textiles, leather, paper, or plastic sheeting. This significantly improves upon conventional art in the area which favors non woven material for the substrate for the glass bead lenses. The result being a structurally and functionally improved micro glass bead engagement with a flexible woven substrate, and a fabric with significantly improved reflective qualities.

Because of the improved appearance, softness, permeability, and wider angles of light reflection of the produced fabric from the disclosed method herein, the resulting product not only significantly enhances safety garments, it allows for the employment of the produced reflective fabric within the mainstream of the fashion garment industry such as for dresses or other clothing where reflective qualities are part of the ornamental design aspect.

Additionally, the fabric produced by the method herein, to mount the micro reflective glass lenses to the matrix at varying reflective angles, may also be followed to yield fabric from the method which may be employed as photographic background screen. This is because of the wide reflective observation angles yielded by the engaged glass beads to the flexible fabric substrate.

As noted, the method yielding the reflective fabric herein is not limited to the production of reflective strips which are later appliqued in the conventional fashion. Instead, using the method herein disclosed, to adhere the glass bead lenses to a substrate, the resulting reflective portions on the substrate or garment may be any graphic pattern or type of indica. This allows for the positioning of reflective lettering, figures, patterns, or any other graphic which may be desirable.

A particularly notable element of the method herein is that it does not require a heat transfer for adhesion. Instead, the graphic pattern producing the resulting indica, can be isolated or continuous graphic patterns which do not require a peeling off or removal of stripes from the solid reflective sheeting.

Because of the high degree of accuracy provided by the disclosed method, the gap between each of the graphic patterns can be 0.5 mm or larger thereby allowing a much more detailed and complicated graphic pattern or indica to be imparted to the base material. When the disclosed method is employed with an area of coverage of the retro-reflective graphic matrix of sufficient quantity, the reflectivity of the product from the method herein can easily meet or exceed the standards for reflectivity required by ANSI/ISEA.

It is thus an object of this invention is the provision of reflective material employing glass beads, which are easily engaged to an underlying flexible fabric substrate.

An additional object of this invention is the provision of such a reflective material which during adhesion to clothing or the like, will not mar or discolor the clothing material.

Yet another object of this invention is to provide such an adherable reflective material, that is not easily affected by temperature during shipment or actual application to the underlying substrate, such as heat transfer type of reflective tapes.

Still further, an object of this invention is the production of reflective fabric on a flexible woven or knitted substrate, which has a high degree of reflectivity, and which provides for the formation of designs or indica in the resulting adhered reflective glass bead lenses.

These together with other objects and advantages which will become subsequently apparent, reside in the details of the construction and operation of the method and device as more fully hereinafter described and claimed, reference being had to the accompanying drawings forming a part thereof, wherein like numerals refer to like parts throughout.

### BRIEF DESCRIPTION OF THE DRAWINGS

FIG. 1 is a cross-section view depicting the retro-reflective material, and the definitions of the entrance angle and observation angle of the light beam.

FIG. 2 is an enlarged cross-section view of binder adhesive material with micro glass bead lenses partially embedded. The curve of the binder material placed on the substrate causes a plurality of reflective angles in the engaged micro glass bead lenses.

FIG. 3 depicts a cross section of the fabric layer with a first adhesive layer attached.

FIG. 3a depicts a cross section view showing the beads engaged to a film on their clear side, being engaged to a layer of adhesive on the fabric material.

FIG. 3b shows the device from FIG. 3a after the film is removed leaving all of the clear portions of the beads exposed and the metalized sides engaged in the adhesive.

FIG. 4 is a cross-section view of the retro-reflective material from the method herein, wherein the micro glass bead lenses are engaged to the adhesive of the binder matrix in plurality of individual lenses facing different directions by sprinkling them thereon instead of employing the film to position them.

FIG. 4a is a cross-section view of conventional prior art retro-reflective material wherein all micro glass bead lenses are facing the same direction by employing a film engagement to the beads on the clear surface wherein only a single adhesive layer has been applied.

FIG. 4b depicts the micro glass beads engaged to the film on their clear side and coated with a metalized coating on the opposite side once so engaged.

FIG. 5 is a cross-section view of a conventional prior art retro-reflective material produced with an ink method, where the micro glass bead lenses are buried in the bonding material and lose reflectivity.

FIG. 6 depicts a product of the method herein wherein a garment such as a conventional safety vest is provided with an enhanced appearance.

FIG. 7 shows a product of the method herein wherein the reflective material produced is applied to fashion garment.

FIG. 8 is the enlarged view of combining two different designs of graphic matrix to outline indica as a graphic image.

FIG. 9 shows a product of the method herein wherein the produced material has indicia in the form of different graphic shapes.

### DETAIL DESCRIPTION OF THE INVENTION

Referring now to the drawings 1-9 wherein similar parts are identified by like reference numerals which may be found in one or more of the drawings, the method herein provides a significant improvement in the production of retro reflective material 10 from glass beads 12 adhered to a substrate 14. As noted the substrate 14 may be any fabric such as woven or knitted or spun bond or other textiles, or paper, leather, or plastic sheeting.

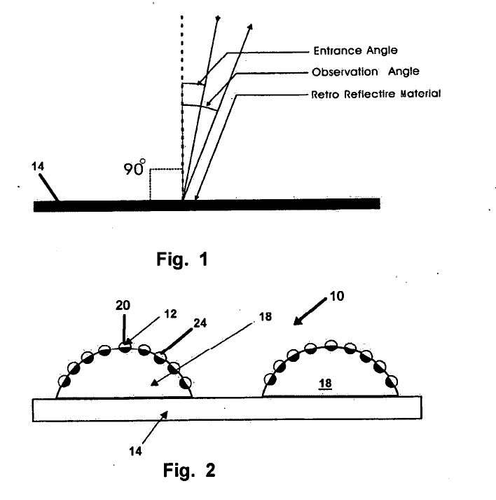

As depicted in figures, the method herein yields a reflective fabric 10 which has substantial improvements over traditional fabrics. Shown in FIG. 1, the retro reflective material 10 produces a reflection of incoming light from one angle, at a reflected angle. The term of “retro-reflective” used in this specification is defined as where the majority of a light beam incident onto the reflective surface of the reflective material 10 is directed back toward the incoming light source. Employing the method herein, the reflective material 10 provides a retro-reflective effectiveness covering wider entrance and observation angle given a plane normal to surface of the base material 16 providing the substrate for the adhesive binder matrix 18 which as noted may be applied to the substrate 14 in graphic shapes to yield any type of indicia or in the dots such as FIG. 2 to provide a plurality of angles of reflection of the beads 12.

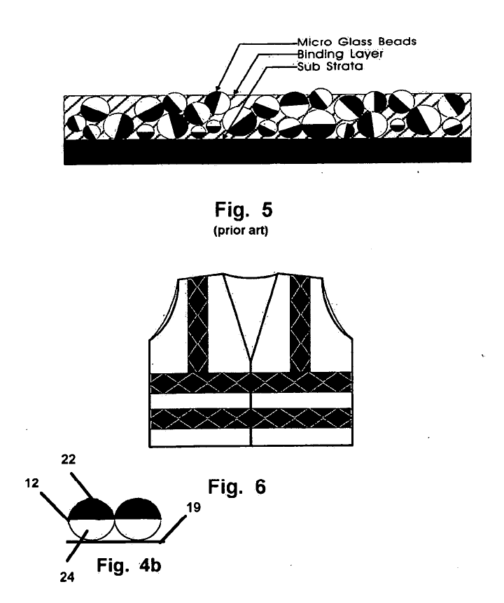

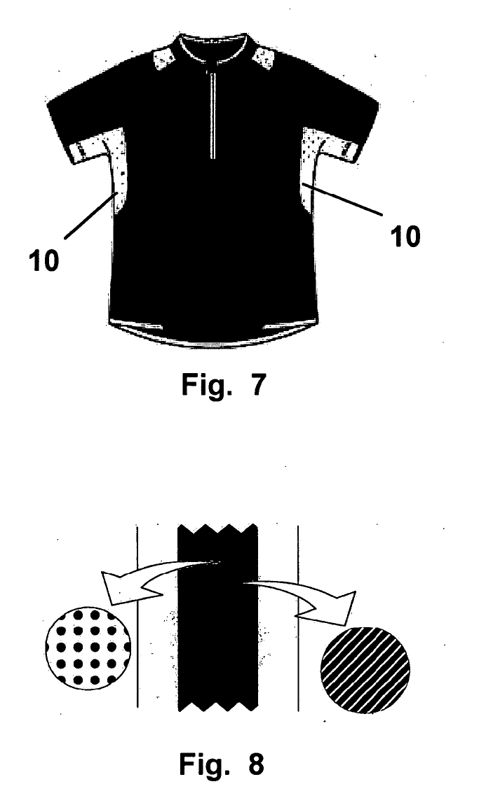

The binder matrix 18 as noted earlier in the specification may be a single layer of adhesive as in FIG. 4a wherein the beads 12 are placed in the binder matrix 18 while still attached to the film 19 shown in FIG. 4b. Once the binder matrix has dried or cured, the film 19 may be removed thereby leaving all the beads 12 with their metallized surface 22 engaged to the binder matrix 18 and the clear lenses 20 exposed.

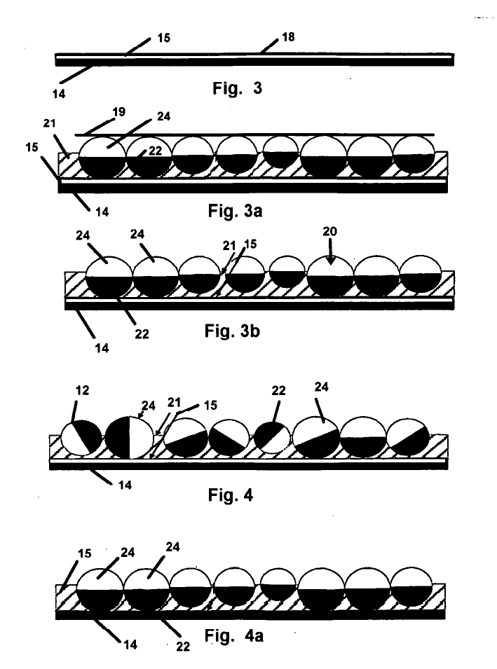

In the preferred modes of the device and method, to the binder matrix 18, be it one layer as in FIG. 4a, or two layers of adhesive as in FIGS. 3a-4, there is partially embedded a plurality of the micro glass bead lenses 20 having a metalized surface 22 on a surface opposite a clear lens 24. Such micro glass bead lenses 20 are preferred in a glass sphere shape and having a refractive index in the range from 1.9 to 2.0. In the current preferred mode of the disclosed method and device herein, the size of the glass bead lens 20 is from thirty microns to eighty microns in diameter. However, any size that would occur to those skilled in the art is anticipated.

In preparation for engagement to the binder matrix 18, each glass bead lens 20 beads is coated hemispherically by vacuum depositing aluminum vapor to achieve the metalized surface 22 opposite the clear lens 24 of the other hemisphere. This is done while the clear lens 24 side of the beads 12 is engaged to a film 19, as noted above, thereby placing all of the beads 12 engaged to the film 19 with their clear lens 24 on the same side, and the metallized surface 22 all facing upward on the opposite side. The micro glass bead lenses 20 used in the process may be prepared by sprinkling a mono layer of clear and transparent micro glass bead lenses 20 onto the film 19 or other paper or plastic sheeting. In a next step, the metallized surface 22 is applied to bead lenses 20 engaged to the film 19, thereby forming the thin aluminum layer of the metallized surface 22 on the side opposite the film 19. There is thus produced a plurality of micro glass beads 20 with each having the metalized surface 22 on the same side with the beads 20 in a registered engagement to the film 19. The micro glass beads 20 in the metallized bead sheeting may be scraped down by rubbing or washing. The resulting micro glass beads 20 collected in the above step have been coated hemispherically by aluminum to products the micro glass bead lens 20 having the reflective metallized surface 22 on one surface.

As those skilled in the art will realize, the micro glass beads 20 may be produced independently of the method herein stored for use rather than produced in a separate step. Such is anticipated by this patent application since metallized coating directly on a surface of the glass beads may be accomplished in the aforementioned fashion by commercial vendors of such products.

Employing the micro glass beads 20 with the metallized surface 22, the reflective material 10 is produced by adhering the micro glass beads 20 to a substrate 14 material using a binder matrix 18 formed of one or a plurality of layers of adhesive material.

To that end, in a first step, a binding matrix 18 in FIG. 3, an adhesive formula having adequate viscosity and proper cross link so that it may create adequate bonding to both the base material employed for the substrate 14 and the micro glass bead lenses 20 is employed. The adhesive used in this first layer of adhesive 15, if only one is used, is of a thickness and viscosity such that the glass bead lenses 20 will not sink into the binding matrix 18 when they are applied thereto. If only one layer is employed of the binder matrix 18 the beads 20 will be adhered therein using the film 19 as shown in FIG. 3a to position the bead lenses 20 facing up, and the metallized surface 22 on the opposite side in the binder matrix 18. The film 19 being removed thereafter, all the beads 20 are facing upward as in FIG. 4a.

If two layers of adhesive are employed as in FIGS. 3-4, the first layer of adhesive 15 forming the binding matrix 18 is placed on the substrate 14 and then the second layer of adhesive 21 is placed on the first layer of adhesive 15. Thereafter the beads 20 with their bead lenses 20 engaged to the film 19 are placed into the second layer of adhesive 21 which is allowed to cure sufficiently such that the film 19 may be pulled from the bead lenses 20 and leave all of the bead lenses 20 facing outward and the metallized surfaces 22 reflecting through the bead lenses 20. Alternatively, the bead lenses 20 may be sprinkled upon the binder matrix 18 formed of one or two layers of adhesives as shown in FIG. 4 wherein two layers of adhesive are used.

As noted two preferred types of bonding agents may be employed in layers forming the binder matrix 18. The first layer 15 is a thin layer of thermal polymerization type of adhesive applied at about 100-180 degrees Centigrade. On that first layer 15 is placed a second layer of adhesive 21 which is of a hot melt type of adhesive.

By using two layers of adhesive for the binder matrix 18 in this fashion, the second layer of adhesive 21 is cured with conventional thermal curing devices while the bead lenses 22 are engaged but before they sink and the second layer of adhesive 21 is prevented from bleeding to cover the front, or clear lens 24 of the micro glass bead. Further, by employing this controlled curing with temperature and timing the viscosity of the mixture of the second layer of adhesive 21 is controlled to keep the beads from sinking and thereby adhering all of them to the top surface of the second layer of adhesive 21 in one direction and with no degradation of the reflect on from the metalized surface 22 which occurs with conventional fabrics. The temperature to yield the proper viscosity is from 100 degree to 200 degree C., and the time is from 30 second to 3 minutes. The viscosity is thereby varied thereby from 1000 to 2000 cps.

While those skilled in the art will realize upon reading this disclosure that there are many types of adhesive useable for this purpose. But to make the end product durable for washing and abrasion, the formula and the process need to be adjusted depend on the base fabric material, the color pigment, and surface treatment.

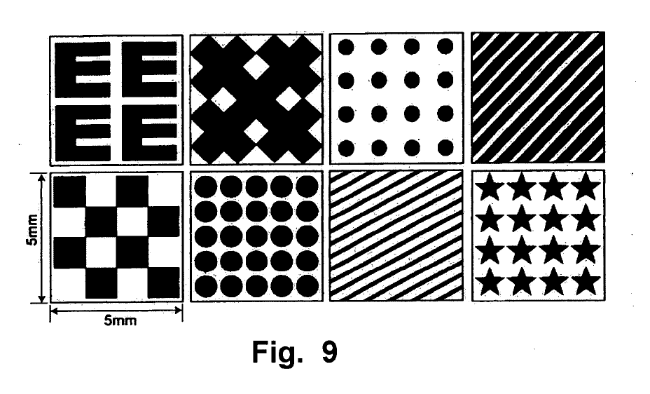

The process in the disclosed method herein can be employed to yield excellent graphics and indica on the substrate 14 forming a garment. Using the noted construction above, in a first step a binder matrix 18 is applied to the substrate 14 in arrays of graphic shape or indica desired. The graphic shape sizes are from 1 mm width of length and up. The graphic shape, as shown in FIG. 9, could be straight line, curve, isolated shape, repetitive, or non-repetitive. The gap between each graphic shape is from 0.5 mm and up. The array of the above graphic shape is defined “graphic matrix” in this specification. The total percentage of the binder coverage or graphic matrix coverage can be from 1% and up depending on the usage of the final products. The “micro glass bead lenses” or “metallized bead sheeting” are then applied to the binder matrix 18 in either one but preferably two layers noted above, before the binder material 18 is cured.

As noted, the resulting product manufactured by the process in the proposed patent can be applied to the following fields: applique for safety garment, fabric for safety garment, fabric for fashion garment, fabric for rainwear and chromatic screen.

As applique, the retro-reflective fabric manufactured by the process of the proposed patent can be slit into stripes and sewn to the safety garment so that the garment can meet the ANSI/ISEA standard, see Reference 1. While the base material or a fabric substrate 14 been coated with the binder matrix 18 in full coverage, the above process can produce a solid reflective fabric with retro-reflective index close to 600 cd/(lx−m2), much higher than what required in the ANSI/ISEA standard 330 cd/(lx−m2). That when the “graphic matrix” has a coverage of total area of proportionally less than full coverage, the applique as part of the safety garment will still meet the ANSI/ISEA standard.

The retro-reflective fabric manufactured by the method herein can also be used as the body of safety garment such as in FIG. 6. In such a mode, the substrate 14 would be a fluorescent fabric, and then the substrate 14 from that fabric can be made into garment and meet with the ANSI standard. The “graphic matrix” can be designed to cover sufficient area on the garment to meet with the same standard. For an ANSI/ISEA standard, Class 2 garment, which requires reflective area to be 203 square inches, about 30-40% coverage area of a substrate 14 forming the safety vest. The “graphic matrix” can be designed to cover 30-40% of the fabric surface to meet with the standard.

Because the retro-reflective fabric manufactured using the device and method herein has graphic appearance yet is comfortable to wear, the resulting fabric may be employed in the fashion industry to yield shiny garments in whole or part

Still further, the retro-reflective fabric disclosed herein is suitable for making a chromatic screen for photographing background screens. The background screen or wall material used in the traditional photographic studio is general painted in blue or green color. The blue or green background is used in traditional studios for replacing the background scenery as part of technique in editing photo pictures, videos, or movies. The background color needs to have a bright background lighting to reveal, and the foreground lighting has to be equal or stronger than the background lighting to balance the intensity of the picture quality.

Due to the combination of strong retro-reflective effect with wide entrance and observation angle effect of the fabric resulting from the device and method herein, the retro-reflective is well adapted to meet the criteria of chromate background screens.

While the present invention has been described herein with reference to particular embodiments thereof, a latitude of modifications, various changes and substitutions are intended in the foregoing disclosures, it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of the abstract of the invention, is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

What is claimed is:

1. A method for making retro reflective material, comprising the steps of:
engaging a curved surface of a plurality of clear glass beads to a film material thereby leaving a second surface, opposite said curved surface and having a reflective coating thereon, exposed;
applying a bonding matrix to a flexible substrate;
positioning said second surfaces of said glass beads upon said bonding matrix;
allowing said bonding matrix to cure; and
removing said film from its engagement with said curved surfaces, thereby positioning said glass beads engaged to said bonding matrix by their respective second surfaces and with substantially all of said respective curved surfaces of said glass beads facing a direction away from said substrate and providing a lens for light reflecting from said reflective coating.

2. The method for making retro reflective material of claim 1 additionally comprising the steps of:
applying said bonding matrix in a first adhesive layer and a second adhesive layer;
engaging said second surfaces of said glass beads to said second adhesive layer prior to removing said film from said engagement with said curved surfaces.

3. The method for making retro reflective material of claim 2 additionally comprising the steps of:
applying said first adhesive layer formed of a thermal polymerization type of adhesive applied at about 100-180 degrees Centigrade;
applying said second layer of adhesive to said first layer of adhesive to form said binder matrix, using a hot melt type of adhesive for said second layer; and
curing said second layer of adhesive with a heat generation component to thereby provide a means to cure said second layer of adhesive in a time period to prevent said glass beads from sinking into said second layer and thereby preventing said second layer of adhesive from covering said curved surfaces.

4. The method for making retro reflective material of claim 3 additionally comprising the steps of:
employing said heat generation component to cure said second layer of adhesive at a temperature from 100 degree to 200 degrees Centigrade for a said time period between 30 seconds to 3 minutes.

5. The method for making retro reflective material of claim 4 additionally comprising the steps of:
said temperature and said time period providing a means to vary the viscosity of said second layer of adhesive from 1000 to 2000 cps.

6. The method for making retro reflective material of claim 1 additionally comprising the steps of:
applying said bonding matrix in a graphic matrix, said graphic matrix forming a graphic on said substrate; and
engaging said glass bead beads to said bonding matrix to form said graphic from said glass beads adhered to said graphic matrix.

7. The method for making retro reflective material of claim 2 additionally comprising the steps of:
applying said bonding matrix in a graphic matrix, said graphic matrix forming a graphic on said substrate; and
engaging said glass bead beads to said bonding matrix to form said graphic from said glass beads adhered to said graphic matrix.

8. The method for making retro reflective material of claim 1 additionally comprising the steps of:
employing said glass beads formed of transparent glass with refractive index from 1.9 to 2.0 and a size between 30 micron to 80 micron in diameter; and
employing a thin layer of aluminum as said reflective surface.

9. The method for making retro reflective material of claim 2 additionally comprising the steps of:
employing said glass beads formed of transparent glass with refractive index from 1.9 to 2.0 and a size between 30 micron to 80 micron in diameter; and
employing a thin layer of aluminum as said reflective surface.

10. The method for making retro reflective material of claim 1 additionally comprising the steps of:
employing leather for said substrate.

11. The method for making retro reflective material of claim 2 additionally comprising the steps of:
employing leather for said substrate.

12. The method for making retro reflective material of claim 1 additionally comprising the steps of:
employing plastic sheeting for said substrate.

13. The method for making retro reflective material of claim 2 additionally comprising the steps of:
employing plastic sheeting for said substrate.

14. The method for making retro reflective material of claim 1 additionally comprising the steps of:
coating said lens with transparent color pigments.

15. The method for making retro reflective material of claim 2 additionally comprising the steps of:
coating said lens with transparent color pigments.

16. The method for making retro reflective material of claim 1 additionally comprising the steps of:
applying said bonding matrix in sections having a hemispheric shape on a side opposite from said substrate to which said bonding matrix engages; and
engaging said glass beads to said hemispheric surface.
